(19) United States
(12) Patent Application Publication
(10) Pub. No.: US 2002/0065477 A1
(43) Pub. Date: May 30, 2002

(54) Audio interactive sexual vibrator

(76) Inventors: William Thomas Boyd, Raleigh, NC (US); Chaka Hannah, Raleigh, NC (US); James Donell Fisher, Garner, NC (US); Theodore Kurt Schlatzer, Raleigh, NC (US)

Correspondence Address: 5 Speed Technologies, Ste 105, 829 Purser Dr., Raleigh, NC, 27603, US

(21) Appl. No.: 09/726,660

(22) Filed: Nov. 30, 2000

(51) Int. Cl. A61H 1/00

(52) U.S. Cl. 601/47; 601/46

(57) ABSTRACT

A sexual vibrator including a vibratory mechanism and an audio signal processing circuit for interactive control and modulation of the vibratory mechanism for use before, during and after sexual intercourse. The control unit is generally external to the vibratory unit.

### BACKGROUND OF THE INVENTION

1. Field of the Invention

The present invention relates to hand held and battery operated vibrators with the intended usage being sexual pleasure.

2. Description of Related Art

Throughout the years various types of vibrators and mechanical stimulation devices have been designed and produced from the type with multiple attachments including heat and blowing air as in U.S. Pat. No. 4,722,326. These devices all contain a rudimentary control mechanism that will allow the user to activate or de-activate activate the unit, some will allow variation in speed to suit the user. That is the extent of the interaction between user and device. One device U.S. Pat. No. 5,928,170 allows interaction of a different nature by allowing the user to speak into an on board recorder and play back the sounds during or following sexplay.

An interactive device should not be solely controlled by one source of input. The device should have some built in intelligence so the experience can be enhanced by giving the user unexpected changes in intensity.

Just as a constant noise eventually fades into the background to become unnoticed, so does continual stiulation of a fixed frequency and intensity. The feature of responding to the environment heightens the experience and allows for a more satisfied user.

### SUMMARY OF THE INVENTION

In carrying out principles of the present invention in accordance with a preferred embodiment thereof, an electrical vibration or oscillating device used for sexual stimulation or therapy is equipped with a signal processing unit that reacts in response to signal input, be that signal acoustic, digital, or analog control. The subject invention further comprises a processor that will respond to software control. The invention will accept any audio signal, including but not limited to a microphone, CD player, tape player, video game, or television. Each of the units may be integrated into the device for convenience or may be attached by a cable or other means to an external box. Typically the device will respond to audio input signal and stimulate the user by differing types of vibratory motion, which may be vibratory, oscillatory, thrusting, massaging, rocking, or tactile motion, accordingly by the frequency and level of the audio input. Low frequencies will generally cause more vibration high frequencies. Also, interaction with computer/console games is achieved through writing of special software that will generate codes for the activation and control of the vibratory effect. Interaction with other users at remote locations via the internet, modem, wireless telephones, pagers, or PDA's with software applications is also a method of control of the vibratory effect.

### DETAILED DESCRIPTION OF THE INVENTION

The invention will be comprised of the following—outer housing 12a made of but not limited to the following materials, plastic, wood, metal, with plastic being the preferred materials, audio processing unit printed circuit board 10, which may be intergrated with the unit for compactness of external to the unit in a separate enclosure connected by a cable 5, on/off switch of button 8, variable tactile adjustments 8, 9 to adjust the tactile and audio sensitivity of the processor 11 to the input signal 19, and a bypass switch or button 8 which when engaged will cause the vibrator to behave in a ‘normal’ operation thus not requiring any external input signal, i.e. performs like a normal sexual vibrator, and a cover 12b.

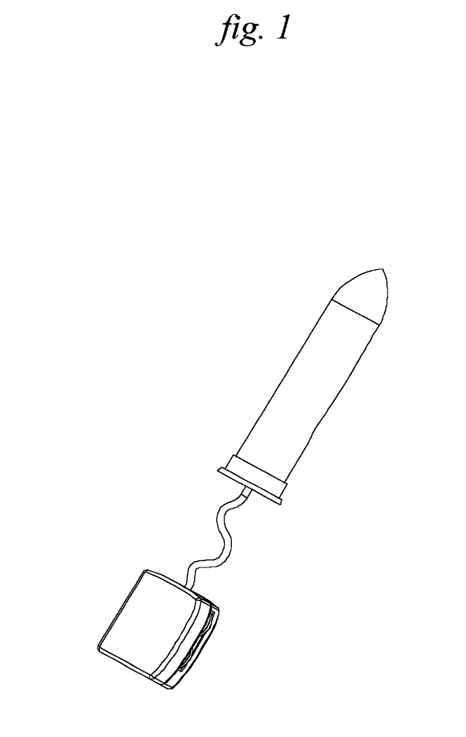

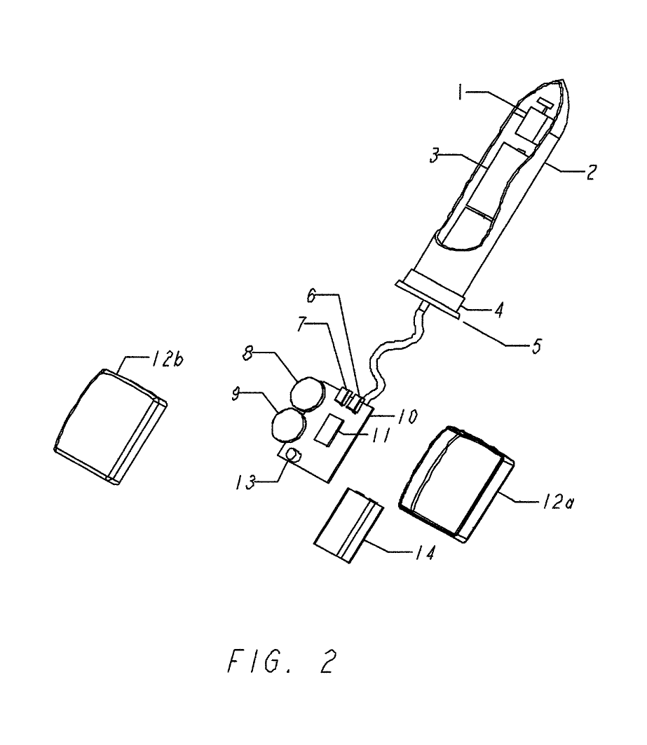

The housing 12a of the invention which may or may not be attached by a cable 5 will be made from a material that is suitable for skin contact, usually but not limited to a phallic shape similar to a human penis to stimulate sexual intercourse. The housing 12a may also be of a smaller type housing just having a vibrating mechanism 2 such as the type shown in FIG. 2 which may be worn for comfort and ease of operation, but for the most part such vibrators are in the shape of a human penis. Generally such devices are made from latex plastic or silicone gel which are pleasing to the touch and for insertion into the body and being round and tapered for easy facilitation into the body orifice or movement on the skin. The housing 12a is typically hollow for holding power circuitry 3 generally being portable batteries, but may be other power sources and the audio processing unit 10, but may be solid with power circuitry and audio processing unit external to the unit in a separate enclosure attached by a cable 5 as referenced by FIG. 1 in the preferred embodiment arrangement. The vibrating mechanism 2 may be a housing that may be merely placed against the male or female genitalia or other sensitive portion of the body and provide stimulation by proximity to the skin. The motion exhibited by the device may be vibratory, but the motion is not limited to vibration. In providing other types of motion the housing may take on various shapes, the stimulation motion may be granted by the following types of motion being, but not limited to vibratory, rototional, rubbing and oscillatory.

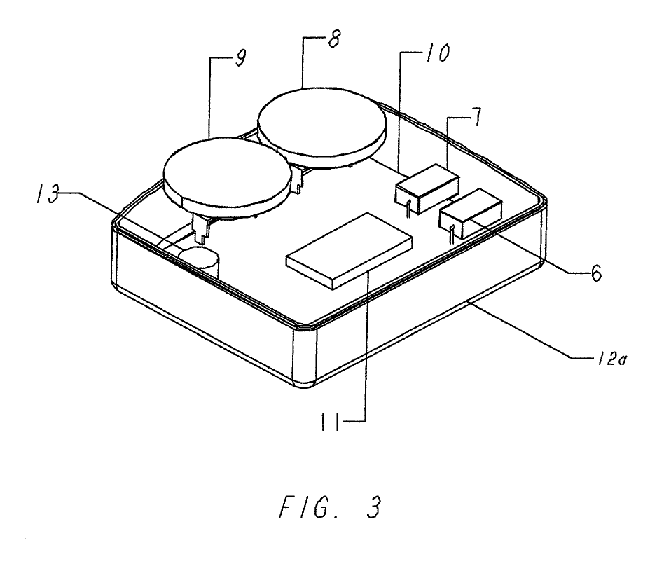

The invention will contain a processor 11 that will consist of control circuitry that will sense the frequency, amplitude of the input and send a corresponding pulse to the vibrating mechanism. See FIG. 3 for a block diagram describing the control circuitry.

The invention will contain a sound bypass circuit which will allow for listening to the audio input with headphones or to another source that will accept input i.e. a computer, guitar amplifier, or home stereo. The preferred embodiment will have this circuit located in the side of the unit; this will allow the user to have interaction with both aural and tactile sensations at the same time, creating a multisensory product. This circuit may be incorporated into a single device, such as an audio jack 7, but the preferred embodiment will be a dedicated electical circuit 10. The invention will utilize a cover 12b to retain the battery(s) 14. The invention may also contain a software interactive processor 11 which consists of control circuitry which accepts codes written in computer/console games or applications to activate the vibratory effect. The device may also contain a cicuit whereby the vibratory effect may be controlled by remote control. The remote control may be operated by utilizing on rf (radio frequency) or ir (infrared) transmission method.

It is an object of the invention to enhance pleasure during sexual intercourse, sexual stimulation, message, marital therapy by providing a vibrator that can react to various audio input, whether it be from a CD player, computer game, record player, tape player or the like.

It is another object of the invention is to provide a device, which can provide comic relief by reducing anxiety during sexual intercourse.

Modes of Operation

There are three distinct modes of operation of the device; Audio Interactive, Computer Interactive and Normal Operation.

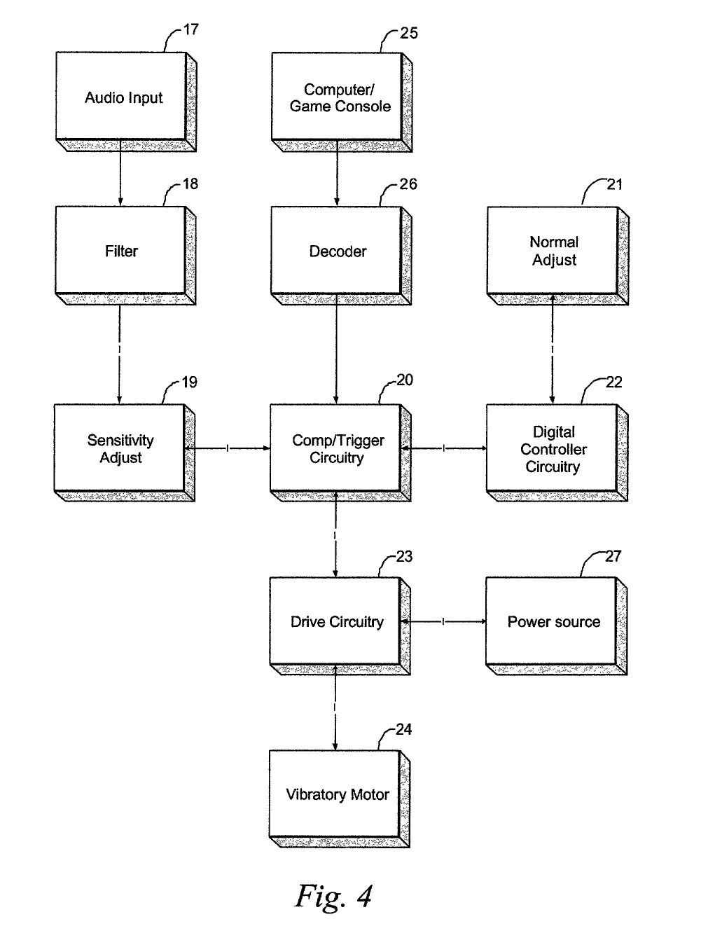

Audio Interactive see Block Diagram in FIG. 4.

When an audio signal is applied to the input 17 it is filtered to extract the trigger frequencies 18, typically between 20 Hz and 200 Hz. Although other frequencies may be used, this range is useful for identifying the beat/rhythm of the music or audio input signal. This is essential to the operation of the device. The extracted signal is then amplified with an adjustment for sensitivity. Sensitivity adjustment, while not required, would be preferred so that the unit might be adjustable to suit an individual's tastes. This signal is then compared to a reference 20 and while the reference is exceeded a signal is sent to the drive circuitry 23. This in turn activates the vibratory motor for a varying duration, thus causing an effect of vibrations corresponding to the beat/rhythm of the music of audio input signal.

Computer Interactive

A connection to a computer or gaming console is made 25. Interactive software titles are writted so that communication through a port such as but not limited to a parallel port, serial port, USB, game port, or Firewire port is accomplished. With this done a micro controller or like device is programmed to decode the information sent from the computer or gaming console 25. This in turn sends a signal of varying duration to the trigger 20 to provide activation and the control of the vibratory motor as described above.

Normal Mode

A ‘normal’ mode is provided with digital level control so that in the event an audio source or computer/videogame is unavaliable, the unit will still function as a vibratory device with level control feature. By manipulating the nomal level adjust, the vibratory motor engages as stated above and will increase or decrease speed corresponding to the position of the adjustment which is sensed and converted to a digital signal by the pwm (pulse width modulation) circuitry in the digital controller 22 and is sent to the trigger 20.

The invention has been described in it's presently contemplated best mode, and it is clear that it is susceptible to numerous modifications, modes and embodiments within the ability of those skilled in the art and without the exercise of inventive faculty. Accordingly, the scope of this invention is defined by the scope of the following claims.

What is claimed is:

1. A stand alone controller for a sexual/massage vibrator comprising:
a housing that encloses the electronic assembly and is connected to a vibrator via a wire, cable, or remote controlled via wireless operation, a battery holder on/off knob or button as well as a high-efficiency pwm speed control knob or button.

2. The controller of claim 1, flrter comprising a circuit to input electrical analog/digital signals and decode into a format that will adjust the speed/level of the vibrating element including a sensitivity adjustment knob or button

3. The controller of claim 2, flrter comprising a microphone and associated circuitry to provide the signals to adjust the speed/level of the vibrating element.

4. The controller of claim 3, integrated into the vibrating element rather than stand-alone.

5. The controllers of claims 3 and 4, further comprising an external power source.

6. The controllers of claim 5. further comprising an output connection for headphones or linking controllers.

7. The controller of claim 5 wherein wireless remote adjustment of speed/sensitivity is used

8. The controller of claim 6 wherein a microcontroller is used as part of the control circuitry.
